(19) United States
(12) Patent Application Publication
(10) Pub. No.: US 2014/0173065 A1
(43) Pub. Date: Jun. 19, 2014

(54) AUTOMATED CONFIGURATION PLANNING

(71) Applicant: SUNGARD AVAILABILITY SERVICES, LP, Wayne, PA (US)

(72) Inventor: Christopher T. Sears, Avondale Estates, GA (US)

(73) Assignee: SUNGARD AVAILABILITY SERVICES, LP, Wayne, PA (US)

(21) Appl. No.: 13/718,283

(22) Filed: Dec. 18, 2012

(51) Int. Cl. H04L 12/24

(52) U.S. Cl. CPC H04L 41/0813
USPC 709/221

(57) ABSTRACT

An Automated Configuration Management System (CMS) assists human operators with administering infrastructure elements in a data center. Configuration state information is collected and stored as a hierarchical set of features and feature attributes. Automated planning tools devise one or more candidate plans given a desired state as input.

### TECHNICAL FIELD

This patent relates to information technology and in particular to automated configuration planning in a data center.

### BACKGROUND

The data center model for providing Information Technology (IT) services allows customers to run their business data processing systems and applications from a centralized facility. Solutions include hosting services, application services, e-mail and collaboration services, network services, managed security services, storage services and replication services. These solutions are suited to organizations that require a secure, highly available and redundant environment.

Such data centers can be located on the customer's premises and can be operated by customer employees. However, the users of data processing equipment increasingly find a remotely hosted service model to be the most flexible, easy, and affordable way to access the data center functions and services they need. By moving physical infrastructure and applications to cloud based servers accessible over the Internet or private networks, customers are free to specify equipment that exactly fits their requirements at the outset, while having the option to adjust with changing future needs on a “pay as you go” basis.

This promise of scalability allows expanding and reconfiguring servers and applications as needs grow, without having to spend for unneeded resources in advance. Additional benefits provided by professional level cloud service providers include access to the most up to date equipment and software with superior performance, security features, disaster recovery services, and easy access to information technology consulting services.

### SUMMARY

As data center capacity expands to support increasing demand, the complexity of configuring the various hardware and software infrastructure elements that make up the data center also grows. As a result, it becomes increasingly difficult to implement configuration changes in a way that does not have unintended consequences. It is not uncommon for a list of the equipment in even a small data center and the corresponding configuration settings to be a document that is many, many pages long with thousands of pieces of discrete information. Orderly management of the data center configuration can thus become a very difficult task without automated tools of some kind.

This idea pertains to an approach for implementing a Configuration Management System (CMS). The CMS is a software program used to automate the configuration of data center infrastructure elements. The CMS specifically uses a particular way to combine data center configuration information with a library of possible actions to generate and evaluate complex change plans. The software program that generates these change plans can use artificial intelligence planning techniques to find an optimal path from some current, initial configuration state to a desired, target state for the infrastructure elements.

The current and target states specify the configuration details of any number of data center infrastructure elements, such as network devices, storage systems, physical servers, virtual servers, operating systems and applications.

The CMS also maintains a library of configuration actions that can be performed. These actions are preferably represented as state transitions in a state space. Each action has a set of preconditions that must be satisfied by the current state for the action to be available. Each action can also specify a set of results or effects, which modify the current state. Each action can also have associated costs.

From the perspective of a planning system, the action library forms the rules in a knowledge base that are used for forward or backwards chaining. If a change action's prerequisites are met, it can be applied to a current state, resulting in a new state. When one or more change actions are applied in a sequence that would result in the initial state being transformed into a new state that corresponds to the target state, then those actions represent a candidate plan. Finding alternate combinations of change actions that also reach the target state can generate multiple candidate plans. An optimum plan can then be chosen from the candidates by scoring them based on criteria, such as comparing the resulting costs (e.g., total execution time or application availability impact).

To implement this automated planning feature, current configuration data on infrastructure elements in the data center is collected, such as on a scheduled basis. This configuration data can, in one implementation, be organized into a hierarchical model of elements with attributes and values. A stored snapshot of this information represents all the attributes and values for an element at a specific point in time, and can be input to the automated configuration planning process as the current state.

A data center can consist of a number of infrastructure elements such as, but not limited to networking devices, physical machines, virtual machines, storage systems, servers, operating systems and applications. Therefore, the specific configuration information collected varies widely, depending on the type of infrastructure elements. For example a file server may return configuration information such as the amount of memory, local disk storage, Operating System (OS) type, OS version, and OS patches installed, applications installed, application versions, and a list of authorized user accounts. A network router, on the other hand, may return a list of active interfaces, interface configurations, and routing table information.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a high level diagram of a service provider level data processing environment that includes several data centers operated as a service for customers.

FIG. 2 is a high level example configuration state.

FIG. 3 illustrates a process implemented by a Configuration Management System (CMS) to generate candidate plans given a current state and desired state.

FIG. 4 details example configuration states including a Microsoft Windows™ update, datastores, hosts, and customer virtual machines.

FIG. 5 contains sample actions.

FIG. 6 illustrates the automated planning system cycle.

### DETAILED DESCRIPTION OF AN EMBODIMENT

### Example Data Center

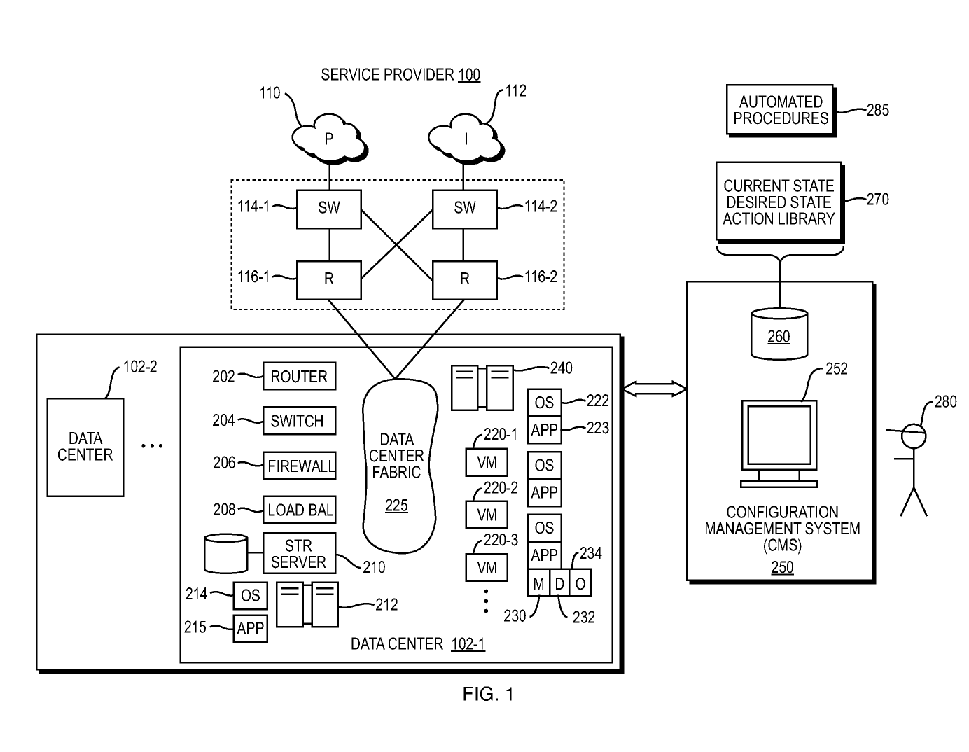

FIG. 1 is a high level diagram of a typical information technology (IT) environment in which the automated configuration planning tools described herein may be used. It should be understood that this is but one example IT environment and many others are possible.

The illustrated IT environment is implemented at a service provider location 100 which makes available one or more data centers 102-1, 102-2 . . . to one or more service customers. The service provider environment includes connections to various networks such as a private network 110 and to the Internet 112 through various switches 114-1, 114-2 and/or routers 116-1, 116-2. The data center level switches 114 and routers 116 provide ingress and egress to the several various data centers 102-1, 102-2 that are hosted at the particular service provider location 100.

In some implementations, these data center level switches 114 and routers 116 are considered to be part of the service provider's infrastructure and thus are not considered to be part of the infrastructure elements that are configurable by the data center customer directly. It is, for example, possible that the details of the operation of the service provider level switches 114 and routers 116 are kept hidden from and are not of concern to the customer. However, in other instances the data center level switches and routers (or portions thereof) may very well be part of the service customer's infrastructure elements and therefore configurable by the customer.

An example data center 102 may include a number of physical and/or virtual infrastructure elements. These infrastructure elements may include, but are not limited to, networking equipment such as routers 202, switches 204, firewalls 206, load balancers 208, storage subsystems 210, and servers 212. The servers 212 may include web servers, database servers, application servers, storage servers, security appliances or other type of machines. Each server 212 typically includes an operating system 214, application software 215 and other data processing services, features, functions, software, and other aspects.

Most modern data centers also support virtual machine clusters that may be implemented on one or more physical machines 240, such that multiple virtual machines 220-1, 220-2, 220-3 are also considered to be part of the data center 102. Each of the VMs 220 also includes an operating system 222, applications 223 and has access to various resources such as memory 230, disk storage 232 and other resources 234, such as virtual local area networks, firewalls, and so forth.

A data center network fabric 225 interconnects the various infrastructure elements in the data center 102 and is not shown in detail for the sake of clarity.

It should also be understood that while shown only a single type of each infrastructure element is shown, a given data center may have multiple routers 202, switches 204, firewalls 206, load balancers 208, storage servers 210, application servers 212, virtual machines 220 and virtual machine clusters 240 and/or other types of infrastructure elements that are not shown or mentioned in detail or at all herein. For example, the virtual machine 220 infrastructure elements may provide functions such as virtual routers, virtual network segments, with each segment having one or more virtual machines operating as servers and/or other virtualized resources such as virtual firewalls.

An administrative user 280 has access to a Configuration Management System 250. The CMS 250 allows the administrator user 280 to review and change the configuration of selected infrastructure elements in the data center 102.

The CMS 250 may itself be located in the same physical location as the data center 102, elsewhere the premises of the service provider 100, at the service customer premises, or remotely located and securely accessing the data center through either the private network 110 or the Internet 112.

The CMS 250 includes a user input/output device 252 (such as a personal computer) and information storage (preferably taking the form of a configuration database 260), as will be understood and described in more detail shortly. The database 260 stores several different types of information concerning the data center 102. Of particular interest here is that the database 260 stores configuration state. The configuration states can include current states 310 and desired states 320 and other states (not shown) such as past states and intermediate states. A current states 310 entry may include live configuration information taken from and relating to the various infrastructure elements in the data center 102. A desired state entry 320 in database 260 may include a new, revised state to be implemented. Also stored in database 260 is an action library 330.

The configuration management system 250 may also include other aspects such as automated procedure systems 285 that perform functions such as security, maintenance, automatic updates and so forth that normally occur without intervention from the administrator user 280. Automated systems 285 include but are not limited to monitoring systems, alerting services, intrusion detection systems, and log analysis services.

Configuration Snapshot State Entry

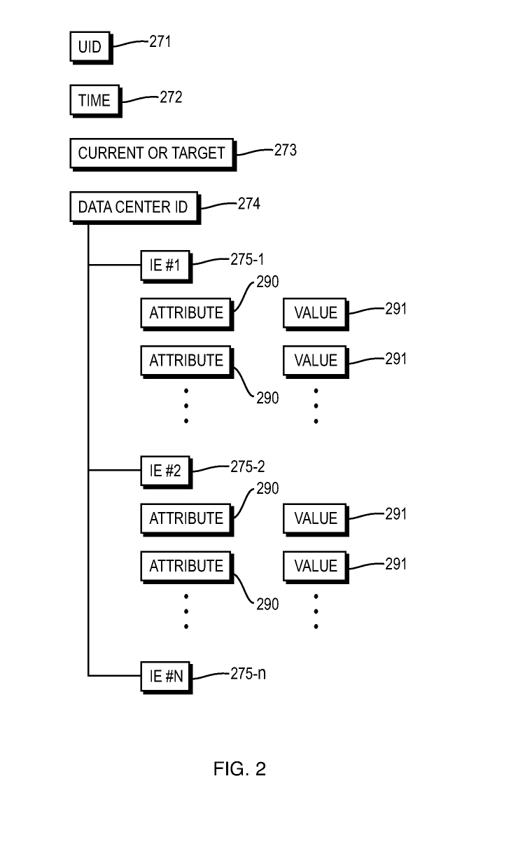

The Configuration Management System (CMS) 250 thus maintains for each data center 102 one or more state entries (current state 310 or desired state 320) 270. These configuration state entries may take a general hierarchical form as shown in FIG. 2. A typical state entry 310 consists of a hierarchal set of attributes and values. It can include for example, a unique ID 271, a time stamp 272, a current state or desired state flag 273, and an identifier 274 for the data center with an associated list of infrastructure elements 275-1, 275-2, . . . , 275-n in data center 274. Each of the data center infrastructure elements 275 has one or more associated attributes 290 and one or more values 291 associated with the attributes 290. It should be understood that the exact configuration of the hierarchy including the number of infrastructure element 275 entries will of course depend upon the configuration of the data center.

The specific attributes 290 and values 291 further depend upon the specific type of each infrastructure elements in the data center. For example, if the infrastructure element is a database server, the configuration attribute information may include an amount of memory, disk size, operating system, operating system version, operating system patches installed, the database application, a list of authorized login accounts, and other information. Snapshot information for infrastructure element that is a communication device such as a switch may include for example a list of active ports, associated host names, and universally unique IDs. A more specific example is discussed in greater detail below.

It should be understood that the types of infrastructure elements to which the principles described herein apply may be different, and therefore the types of configuration information stored is also different depending not only on the data center configuration and the specific infrastructure elements, but also the preferences of the designer of the configuration management system and/or administrative user 280. These details are not a feature of the primary aspect of what is believed to be novel.

Automated Configuration Change Planning

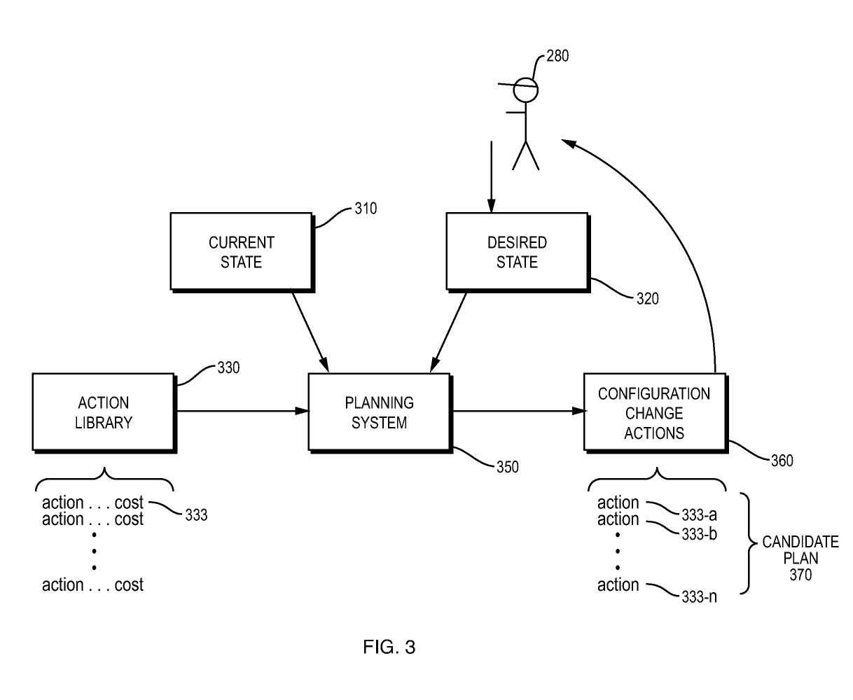

A procedure for assisting the administrative user 280 with changes by automated change management is shown in FIG. 3. The goal here is to not only maintain an accurate representation of the present configuration state of the data center 102 but also to manage the implementation of possible changes to the data center. A desired set of actions can be automatically identified. These actions can subsequently be executed by the administrator or by another software tool to arrive at a target configuration state. The CMS 250 thus helps the human administrator 280 manage configuration changes more effectively.

More particularly, FIG. 3 shows how a current state 310, a desired state 320 and action library 330 are fed as inputs to a planning system 350. The planning system 350 then generates one or more configuration change actions 333-a, 333-b, . . . 333-n that represent a candidate plan 370.

The current state 310 is maintained as data structures according to the general example described in FIG. 2. The desired state 320 could be expressed explicitly as described in FIG. 2, or implicitly by specifying a list of desired criteria a valid state must satisfy. It should be understood that more than one valid state could satisfy such a list of desired criteria. As already explained, the current state 310 is typically determined by collecting actual state information such as on a scheduled basis from the elements of the data center. The desired state 320 may represent a modification to a particular current state such as provided by the administrative user 280 interacting with the database 260. It may also represent a past known good state.

As has been briefly mentioned the database 260 also contains a library of configuration actions as an action library 330. These actions are preferably represented as state transitions in the state space represented by the current state 310 and the desired state 320. Each action in the action library 330 typically includes a set of preconditions that must be satisfied by the current state information for that action to be available. Each action in the action library 330 can also specify a set of effects, expected results, unexpected results which can occur when attempting to modify the current state 310 to result in a desired state 320. Each action may also carry associated costs that are accrued when that action is performed. The cost may be an execution time, down time for one or more infrastructure elements, financial cost, or other optimization criteria.

The planning system 350 therefore takes the current state 310, desired state 320 and action library 330 as inputs and formulates a list of configuration change actions as a candidate plan 370. Any convenient planning system algorithm 350 can be used to derive various candidate plans 370 given the current state 310, designed state 320, action library 330 and associated actions and costs as inputs. If one or more change action 333 has prerequisites that already exist in the current state 310, then those actions 333 are available for use by the planning system 350 in determining how to navigate the state space to achieve the desired state 320.

When one or more change actions 330 are applied together, such as in a sequence of change actions that would result in the current state 310 being transformed into a new state that corresponds to the desired state 320, those actions together can represent a candidate plan 370. Planning system 350 may find alternate combinations of change actions 333 that can also indentify still other candidate plans to reach the desired state 320 given the current state 310.

The planning system 350 can therefore further assist the administrative user 280 by choosing a candidate plan 370 that is optimal according to some overall cost criteria. The criteria may include a cost associated with each candidate plan. An optimal plan can then for example be chosen from the candidate plans 370 by scoring a based on this cost criteria. The cost criteria can be any convenient comparative evaluation of the different candidate plans and associated actions 333 contained in each one, such as total execution time, the time that an infrastructure element remains offline during execution of the plan, financial cost, or other impacts on the data center.

Once the desired candidate plan 370 is identified, that sequence of actions associated with it can be in fact carried out on the infrastructure elements in the data center such that the desired state 320 is reached. However, the CMS 250 may still monitor the infrastructure elements as the actions are executed, and if the actions cause an error or some other known undesirable state to be reached, the CMS 250 may invoke or allow the administrator to invoke the automated planning system to update the plan. If an updated plan can be found to reach the desired state from current undesirable state, the CMS 250 may then chose (either via an automated process or with input from the administrative user) an option to continue executing change actions using the updated plan or aborting the change process. If it is not possible to reach the desired state or the administrator chooses to abort the change, the planning system could be invoked to create a rollback plan to return the system to the original state.

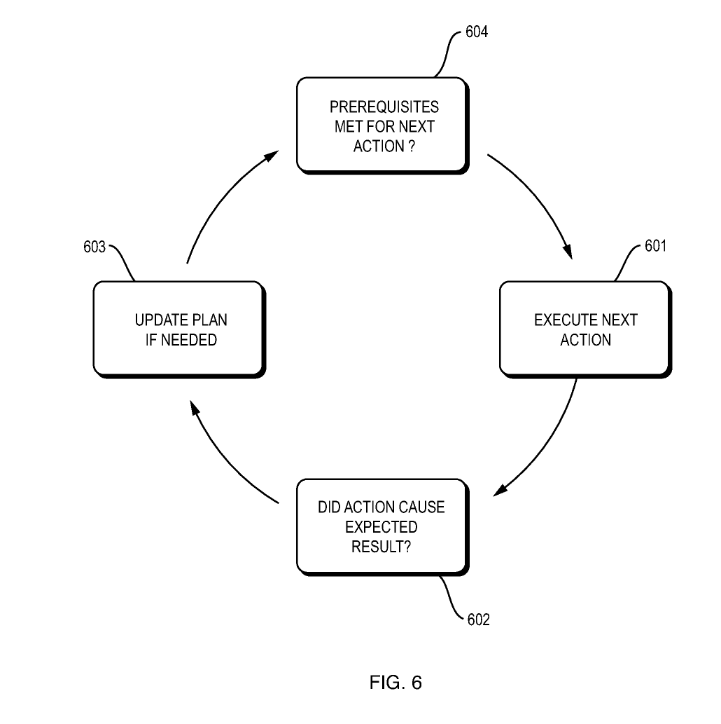

FIG. 6 shows the cycle including execution 601 of the next action in the plan, monitoring 602 to determine if expected results are seen, updating 603 the plan, and determining if prerequisites are met 604 for the next action.

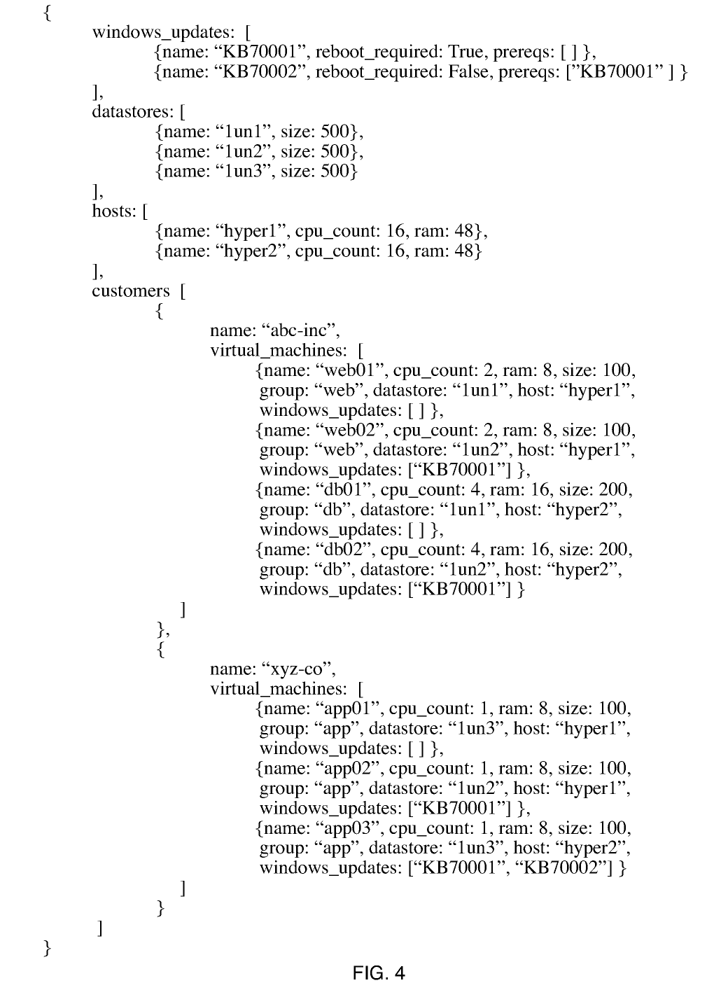

FIG. 4 is a more detailed example of a configuration state entry in the database which may be either a current state 310 or a desired state 320. This simplified sample configuration includes four top-level sections: Windows_updates, datastores, hosts, and customers.

Each example action includes parameters associated with the action, prerequisites needed for the action to be considered as part of the candidate plan, effects of the action and the cost associated with the action.

The “Windows_updates” section defines a list of available Windows updates (patches). Each update can for example include a name (such as “KB 70001”), a flag indicating whether a reboot is required and a list of prerequisite updates that must first be installed before installing dependent updates. In this example, the update KB 70001 must be installed prior to KB 70002 and a reboot is required for KB 70001 but is not required for KB 70002.

The “data stores” section specifies a list of storage resources such as Storage Area Network (SAN) devices that can store virtual machine (VM) definition files. Here each data store is given a name (“LUN1”, for example) and a size in gigabytes.

The “host” sections of this configuration file defined two hosts as physical servers that are available to host virtual machines. Each host has a name, a number of CPU cores (as indicated by CPU_count), and amount of memory in gigabytes (RAM).

The “customers” section defines a list of customer objects which a list of associated virtual machines (VMS). Each VM has a name, a number of virtual CPU cores (CPU_count), an amount of virtual memory in gigabytes (RAM), a virtual disk size in gigabytes (SIZE), a cluster group (GROUP), a current host (HOST), the current data store (DATA STORE) and a list of installed Windows updates (Windows_updates).

It is therefore now understood how the state entries take a general hierarchical form indicating not only data center infrastructure elements but also one or more associated attributes and one or more values associated with the attributes.

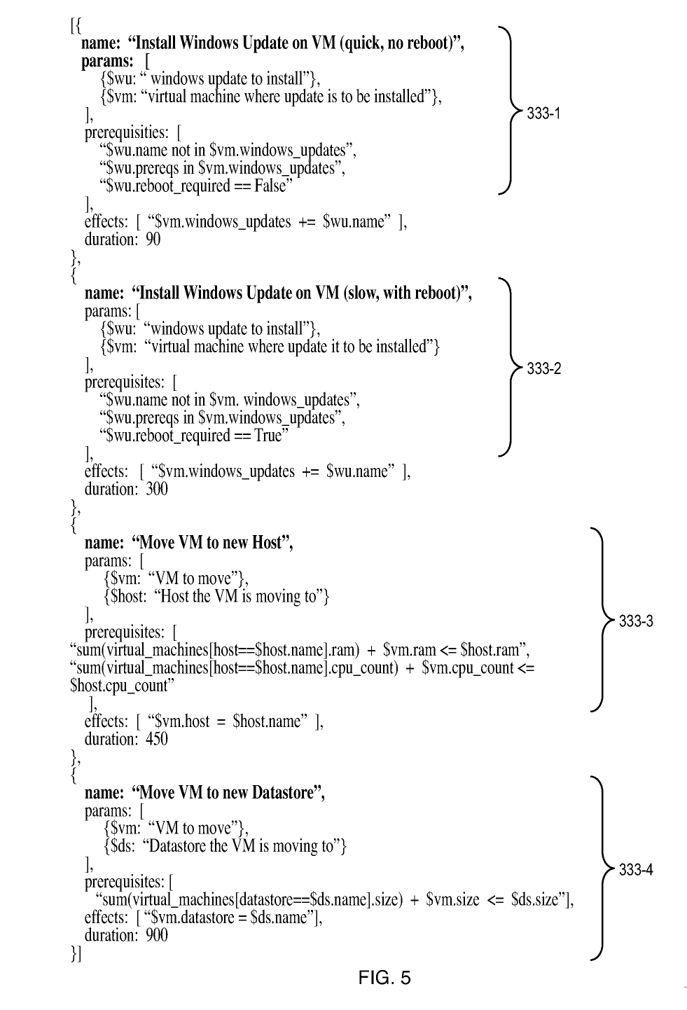

FIG. 5 shows sample actions in the library 330 in more detail. The action library 330 entries here include four actions specified with matching expressions using a JSON (Java Script Object Notation) pseudocode format.

The first action 333-1 is an “Install Windows_update on VM with no reboot” action. This action installs a Windows Operating System (OS)_patch on a virtual machine when that update does not require a reboot. Any prerequisite operating system updates must first have been installed. The logic also ensures that the selected update is not already installed. A further attribute of this action entry is a cost; here indicated as a duration of 90 seconds.

Another example action 333-2 is “install an OS update on a virtual machine with a reboot”. This action will install a Windows OS update on VM where that update requires a reboot. Any prerequisite update must first be installed. The selected update should also not already be installed. The cost associated with this example action is 300 seconds.

The third action 333-3 moves a VM to a new host. Here the action is to migrate a VM to a new physical host server, but only if the amount of total physical memory and CPU count of all VM's on the new host will not become overcommitted. The prerequisites of this action 333-3 therefore check the amount of memory and the number of CPUs available on the candidate new host. The resulting effect is to change the VM host to the new hostname. A, cost associated with this action is 450 seconds.

Example action 333-4 moves a VM to a new data store. The input parameters are an identifier for the VM and an identifier for the data store to which the VM is to be moved. Prerequisites to this action include a requirement that the disk size of all of VM's in the new data store should not become over committed. The cost associated with this section is 900 seconds in duration.

Examples of Automated Planning System Usage

As a first usage example, the administrator specifies a desired state where Windows update KB70002 is installed on all VMs for customer “xyx-co” as fast as possible. After analyzing the Windows update prerequisites and reboot requirements, the planning system would generate the following plan:
1. Install KB70001 on VM app01 and reboot
2. Install KB70002 on VM app01 without a reboot
3. Install KB70002 on VM app02 without a reboot

As a second usage example, the administrator specifies a desired state where customers “abc-inc” and “xyx-co” are not sharing hosts or datastores, in order to isolate each customer from possible performance problems caused by the other. After analyzing host and datastore capacity, the planning system would generate the following plan:
1. Move abc-inc VM web01 to host hyper2
2. Move abc-inc VM web02 to host hyper2
3. Move xyz-co VM app03 to host hyper1
4. Move xyz-co VM app02 to datastore lun3

As a third example, the administrator might specify a desired state where abc-inc VM web01 had a cpu_count of 8. The automated planning system has no action in it's action library to achieve this desired state, so the administrator would be informed that a no plan is possible.

It should be understood that the example embodiments described above may be implemented in many different ways. In some instances, the various “data processors” described herein may each be implemented by a physical or virtual general purpose computer having a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described. As is known in the art, such a computer may contain a system bus, where a bus is a set of hardware lines used for data transfer among the components of a computer or processing system. The bus or busses are essentially shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

The computers that execute the processes described above may be deployed in a cloud computing arrangement that makes available one or more physical and/or virtual data processing machines via a convenient, on-demand network access model to a shared pool of configurable computing resources (e.g., networks, servers, storage, applications, and services) that can be rapidly provisioned and released with minimal management effort or service provider interaction. Such cloud computing deployments are relevant and typically preferred as they allow multiple users to access computing resources as part of a shared marketplace. By aggregating demand from multiple users in central locations, cloud computing environments can be built in data centers that use the best and newest technology, located in the sustainable and/or centralized locations and designed to achieve the greatest per-unit efficiency possible.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

Thus, while this invention has been particularly shown and described with references to example embodiments thereof, it will be understood by those skilled in the art that various changes in form and details may be made therein without departing from the scope of the invention as encompassed by the appended claims.

What is claimed is:

1. A method for automated configuration change planning in a data center comprising:
receiving information concerning a current configuration state including one or more state objects for one or more infrastructure elements, the state objects including attributes and values for the attributes; receiving a target configuration state for at least one infrastructure element in the data center including state objects for one or more infrastructure elements; and
selecting a set of actions to be taken as stored in an action library database, the selected actions, when applied to the current state, comprising a plan that will result in the desired state from the action library to reach the desired configuration state from the initial configuration state.

2. The method of claim 1 further comprising:
executing the plan in the data center to implement the selected actions.

3. The method of claim 1 wherein the plan required to result in a virtual machine being in the desired state comprises more than one action and a change to more than one infrastructure element.

4. The method of claim 2 further comprising at a mid point in the step of executing the plan, scanning one or more states of the data center and comparing them to configuration states expected in the plan; and if the comparison indicates an undesirable state, then updating the plan.

5. The method of claim 1 wherein the configuration state includes one or more configuration objects for a physical or virtual machine in the data center.

6. The method of claim 1 wherein each of the available actions includes a cost, and the cost is considered in devising the plan.

7. The method of claim 1 wherein the initial configuration state is determined from a running instantiation of the data center.

8. The method of claim 1 wherein the desired configuration state corresponds to a past desirable state.

9. The method of claim 1 wherein the plan is devised by selecting the set of actions to be taken from multiple possible sets of actions to be taken that would achieve the desired configuration state by comparing relative costs associated therewith.

10. The method of claim 1 wherein the infrastructure elements include shared resources, and the set of actions to be taken consider resource availability.

11. The method of claim 1 wherein actions specify desired prerequisite conditions, undesired side effects of taking the action, and/or resulting states of taking the action.

12. The method of claim 1 further comprising presenting the plan to a user for approval before the step of executing the plan.

13. The method of claim 1 further comprising presenting multiple plans with associated costs to a user for selection prior to the step of executing the plan.

14. The method of claim 1 further comprising presenting a state of an executing plan to the user and altering the plan according to user input.

15. The method of claim 1 wherein the configuration state comprises a hierarchical set of attributes for one or more infrastructure elements in the data center.

16. A data processing apparatus for automated configuration change planning in a data center comprising:
a configuration manager system (CMS) that sends requests to infrastructure elements of the data center, and receives information concerning a current configuration state including one or more state objects for one or more infrastructure elements, the state objects including attributes and values for the attributes;
a user input interface, for:
receiving a target configuration state for at least one infrastructure element in the data center including state objects for one or more infrastructure elements; and
selecting a set of actions to be taken as stored in an action library database, the selected actions, when applied to the current state, comprising a plan that will result in the desired state from the action library to reach the desired configuration state from the initial configuration state.

17. The apparatus of claim 16 further wherein the CMS executes the plan to implement the selected actions.

18. The apparatus of claim 16 wherein the plan required to result in a virtual machine being in the desired state comprises more than one action and a change to more than one infrastructure element.

19. The apparatus of claim 17 wherein
the CMS further scans one or more states of the data center and compares them to configuration states expected in the plan; and
if the comparison indicates an undesirable state, the CMS then updates the plan.

20. The apparatus of claim 16 wherein the configuration state includes one or more configuration objects for a physical or virtual machine in the data center.

21. The apparatus of claim 16 wherein each of the available actions includes a cost, and the cost is considered in devising the plan.

22. The apparatus of claim 16 wherein the initial configuration state is determined from a running instantiation of the data center.

23. The apparatus of claim 16 wherein the desired configuration state corresponds to a past desirable state.

24. The apparatus of claim 16 wherein the CMS further devises the plan by selecting the set of actions to be taken from multiple possible sets of actions to be taken that would achieve the desired configuration state by comparing relative costs associated therewith.

25. The apparatus of claim 16 wherein the infrastructure elements include shared resources, and the set of actions to be taken consider resource availability.

26. The apparatus of claim 16 wherein actions specify desired prerequisite conditions, undesired side effects of taking the action, and/or resulting states of taking the action.

27. The apparatus of claim 1 wherein the CMS further presents a state of an executing plan to the user, the user input interface accepts user input, and the CMS and alters the plan according to user input.

28. The apparatus of claim 16 wherein the configuration state comprises a hierarchical set of attributes for one or more infrastructure elements in the data center.

29. A programmable computer system product for automated configuration change planning in a data center, the programmable computer system product comprising one or more data processing machines that execute instructions retrieved from a storage media, the instructions for:
receiving information concerning a current configuration state including one or more state objects for one or more infrastructure elements, the state objects including attributes and values for the attributes; receiving a target configuration state for at least one infrastructure element in the data center including state objects for one or more infrastructure elements; and
selecting a set of actions to be taken as stored in an action library database, the selected actions, when applied to the current state, comprising a plan that will result in the desired state from the action library to reach the desired configuration state from the initial configuration state.
